(19) United States
(12) Patent Application Publication
(10) Pub. No.: US 2008/0164812 A1
(43) Pub. Date: Jul. 10, 2008

(54) METHOD FOR FABRICATING A SYSTEM FOR DISPLAYING IMAGES

(75) Inventors: Yaw-Ming Tsai, Taichung County (TW); Liang-Jyi Chen, Taipei City (TW); Po-Yen Lu, Taoyuan County (TW); Chung-Chih Wu, Taipei City (TW); Yin-Jui Lu, Tainan City (TW); Chun-Liang Lin, Jhonghe City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: TPO DISPLAYS CORP., Miao-Li County (TW); NATIONAL TAIWAN UNIVERSITY, Taipei City (TW)

(21) Appl. No.: 11/620,814

(22) Filed: Jan. 8, 2007

(51) Int. Cl. H01J 1/70

(52) U.S. Cl. 313/509

(57) ABSTRACT

Systems for displaying images. A representative system incorporates an electroluminescent diode that comprises a substrate, an anode formed on the substrate, electroluminescent layers formed on the anode, a cathode formed on the electroluminescent layers, and a wavelength narrowing mirror structure formed directly on the cathode. Particularly, the wavelength narrowing mirror structure comprises a plurality of metal layers, and two adjacent metal layers separated by a dielectric layer.

### BACKGROUND OF THE INVENTION

1. Field of the Invention

The invention relates to displaying of images using electroluminescence.

2. Description of the Related Art

Recently, with the development and wide application of electronic products, such as mobile phones, PDAs, and notebook computers, there has been increasing demand for flat display elements which consume less electric power and occupy less space. Among flat panel displays, organic electroluminescent devices are self-emitting, and highly luminous, with wider viewing angle, faster response, and relatively simple fabrication, making them the industry display of choice.

An organic light-emitting diode (OLED) is a light-emitting diode that uses an organic layer as the active layer. In recent years, OLEDs have been gradually employed in flat panel displays. The trend in organic electroluminescent display technology is for higher luminescent efficiency, longer lifetime and full color emission.

Several methods have been employed to achieve full color emission in organic electroluminescent devices, including direct full-color display techniques and indirect full-color display techniques.

In the direct full-color display technique, there is a major tendency to fabricate full color organic electroluminescent devices by a method of RGB emitting layers. The so-called method of RGB emitting layers indicates that red, green and blue color arrays are formed, and then driven by bias voltages to emit red, green and blue, respectively. The individual aging rates of RGB organic electroluminescent materials, however, are different and lead to color deterioration of the organic electroluminescent device after a period of time.

Accordingly, a full-color organic electroluminescent device with a color filter has been developed to solve the problems caused by the above full-color organic electroluminescent devices. In particular, white light emitted from a white organic light emitting diode is converted to RGB by passing through the RGB color filters.

Nevertheless, since the RGB emission spectrum of the white OLED does not precisely correspond to the RGB transmission spectrum of RGB color filters, the spectral FWHM (Full Width Half Maximum) of the filtered RGB luminescence has been enlarged and reduced, such that color saturation (NTSC ratio) of the full-color display employing the white OLED and RGB color filters has been reduced, limiting the color range thereof.

To narrow the spectral FWHM (Full Width Half Maximum) and increase the color saturation (NTSC ratio), an OLED emission element within a microcavity structure has been provided to enhance emission at a specific wavelength as determined by the optical cavity length of the microcavity. Examples of such microcavity devices are disclosed in U.S. Pat. Nos. 5,405,710 and 5,554,911. In this case, use of broad emitting OLED materials, varying the optical length of the cavity for each differently colored sub-pixel, can provide different colored emission.

However, when devices constructed with microcavities are viewed at varying angles, the color of the emission may change. Further, fabrication of the microcavities entails increased process complexity and cost.

Therefore, it is necessary to develop a simple and efficient manufacturing method and structure for a full-color organic electroluminescent device.

### BRIEF SUMMARY OF THE INVENTION

Systems for displaying images are provided. An exemplary embodiment of a system comprises an electroluminescent device that comprises: a substrate; a first electrode located on the substrate; electroluminescent layers located on the first electrode; a second electrode located on the electroluminescent layers; and a wavelength narrowing mirror structure located directly on the second electrode, wherein the wavelength narrowing mirror structure comprises a plurality of metal layers, with two adjacent ones of the metal layers being separated by a dielectric layer. Another exemplary embodiment of the system comprises an electroluminescent device, comprising: a substrate; and a wavelength narrowing mirror structure located on the substrate, wherein the wavelength narrowing mirror structure comprises a plurality of metal layers with two adjacent ones of the metal layers being separated by a dielectric layer, the electroluminescent device being operative to emit red, green, and blue (RGB) emissions, wherein the wavelength narrowing mirror structure increases saturation of the RGB emissions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section of a bottom-emission organic electroluminescent device according to an embodiment of the invention.

FIGS. 2a to 2c are cross sections of a wavelength narrowing mirror structure according to embodiments of the invention.

FIG. 3 is a cross section of a top-emission organic electroluminescent device according to one embodiment of the invention.

FIG. 4 shows a graph plotting operating voltage against current density of electroluminescent devices as disclosed in Comparative Example 1 and Example 1.

FIGS. 5 and 6 show electroluminescent spectra as described respectively in Comparative Example 1 and Example 1.

FIGS. 7 and 8 show electroluminescent spectra as described respectively in Comparative Example 1 and Example 1, after passing through the RGB color filters.

FIG. 9 shows a graph plotting color saturation of the electroluminescent devices as disclosed in Comparative Example 1 and Example 1.

FIG. 10 schematically shows another embodiment of a system for displaying images.

### DETAILED DESCRIPTION OF THE INVENTION

This description is made for the purpose of illustrating the general principles of the invention and should not be taken in a limiting sense. The scope of the invention is best determined by reference to the appended claims.

In this regard, systems for displaying images are provided, in which some embodiments employ a wavelength narrowing mirror structure to narrow the spectral FWHM (Full Width Half Maximum) of emitted light, thereby facilitating color saturation (NTSC ratio).

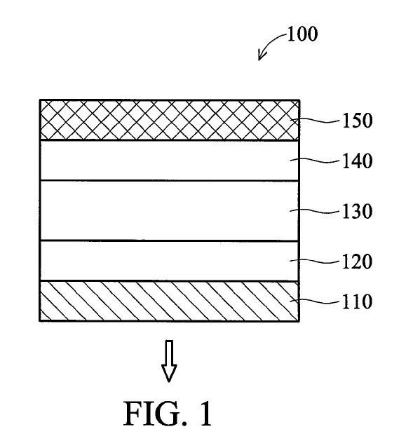

As shown in FIG. 1, an organic electroluminescent diode 100 according to an embodiment of the invention comprises a substrate 110 of an insulating material such as quartz, glass, plastic, or ceramic.

Further, the substrate 110 is a transparent substrate since the organic electroluminescent diode 100 is a bottom-emission organic electroluminescent device.

A first electrode 120 is formed on the substrate 110, and can be a transparent electrode, comprising indium tin oxide (ITO), indium zinc oxide (IZO), aluminum zinc oxide (AZO), zinc oxide (ZnO), SnO2, In2O3, or combinations thereof, formed by, for example, sputtering, electron beam evaporation, thermal evaporation, or chemical vapor deposition.

An electroluminescent layer 130 is formed on the electrode 120, comprising at least a light emitting layer, and can further comprise a hole injection layer, a hole transport layer, an electron transport layer, and an electron injection layer. The electroluminescent layer 130 is organic semiconductor material such as small molecule material, polymer, or organometallic complex, and can be formed by thermal vacuum evaporation, spin coating, dip coating, roll-coating, injection-fill, embossing, stamping, physical vapor deposition, or chemical vapor deposition. The emitting layer can comprise one or multiple light-emitting material and electroluminescent dopants doped into the light-emitting materials and can perform energy transfer or carrier trapping under electron-hole recombination in the emitting layer. The light-emitting material can be fluorescent or phosphorescent.

It should be noted that the electroluminescent layer 130 can comprise a single electroluminescent unit, resulting in an organic electroluminescent diode 100 with red, blue, yellow, or green emission. Further, the electroluminescent layer can comprise a plurality of electroluminescent units, such that a tandem organic electroluminescent diode 100 with white emission can be achieved by mixing different colors.

Next, a second electrode 140, is formed on the electroluminescent layer 130. Suitable material of the electrode 140 can comprise indium tin oxide (ITO), indium zinc oxide (IZO), aluminum zinc oxide (AZO), zinc oxide (ZnO), SnO2, In2O3, Al, Cu, Mo, Ti, Pt, Ir, Ni, Cr, Ag, Au or combinations thereof, formed by, for example, sputtering, electron beam evaporation, thermal evaporation, or chemical vapor deposition. Particularly, the metal materials such as Al, Cu, Mo, Ti, Pt, Ir, Ni, Cr, Ag, Au or combinations thereof are transparent or semitransparent.

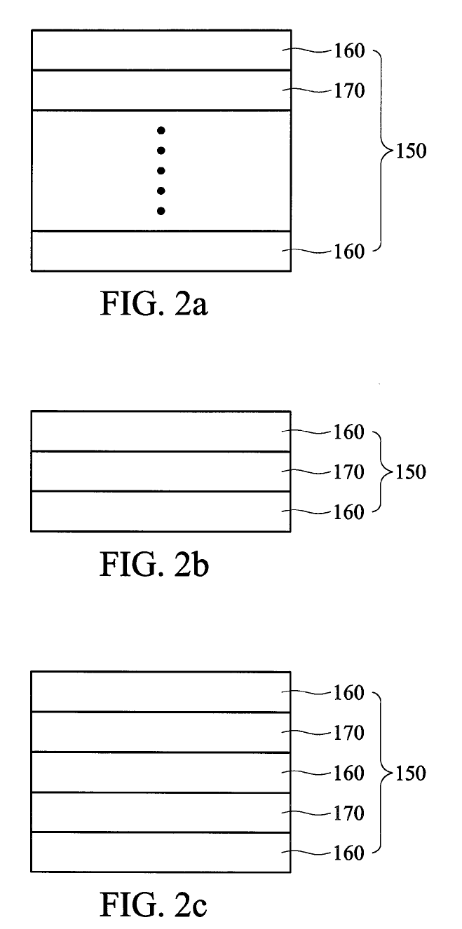

Still referring to FIG. 1, a wavelength narrowing mirror structure 150 is formed on the second electrode 140. As shown in greater detail in FIG. 2a, the wavelength narrowing mirror structure 150 comprises a plurality of metal layers 160, and two adjacent metal layers separated by a dielectric layer 170, narrowing the spectral FWHM of emitted light of the organic electroluminescent diode, further increasing the color saturation (NTSC ratio). The wavelength narrowing mirror structure 150 directly contacts the second electrode 140 through the metal layer 160. In an embodiment of the invention, referring to FIG. 2b, the wavelength narrowing mirror structure 150 comprises two metal layers 160 separated by one dielectric layer 170. In another embodiment of the invention, referring to FIG. 2c, the wavelength narrowing mirror structure 150 can comprise three metal layers 160, and two adjacent metal layers 160 separated by one dielectric layer 170.

Particularly, the metal layers can be formed of the same or different materials. Additionally, the metal layers can be transparent or semitransparent, otherwise the reflection of the mirror can become similar to those formed of thick metal layers, which potentially renders the bandwidth-narrowing function of the mirror useless. Suitable materials are Mg, Ca, Al, Ba, Li, Be, Sr, Ag, Au or combinations thereof. Further, the dielectric layer can be an inorganic or organic compound, such as TeO2, ITO, ZrO, ZnO, ZnSe, ZnS, MgO, Si3N4, SiO2, LiF, MgF2, NaF, CaF2, m-MTDATA, α-NPD, TPD, ADN, Alq₃, or combinations thereof. It should be noted that the thickness of the dielectric layer depends on the designed working spectral region of the wavelength narrowing mirror and thickness of other layers within the wavelength narrowing mirror.

The reason that the wavelength narrowing mirror can narrow the spectral width is given in the following. Referring to FIG. 1, the directly-emitting emission interferes with the emission reflected from the wavelength narrowing mirror structure 150, thus determining the outcoupled emission spectrum and intensity of the diode 100. In order to narrow the spectral width of the outcoupled emission, the structure of the mirror is designed such that constructive interference occurs in a desired spectral region, while destructive interference occurs in an unwanted spectral region. Therefore, the emission in the unwanted spectral region is suppressed, and thus the spectral width is narrowed.

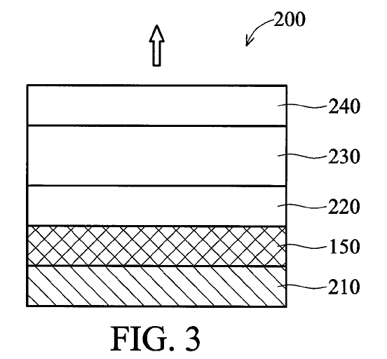

According to another embodiment of the invention, as shown in FIG. 3, a top-emission organic electroluminescent diode 200 is provided. The organic electroluminescent diode 200 comprises a substrate 210 of a transparent insulating material such as quartz, glass, plastic, or ceramic. Further, the substrate 210 can be an opaque substrate such as semiconductor substrate since the organic electroluminescent diode 200 is a top-emission organic electroluminescent device.

Next, a wavelength narrowing mirror structure 150 is formed on the substrate 210. It should be noted that wavelength narrowing mirror structure 150 directly contacts the substrate 210 through the metal layer 160. It should be noted that mirror 150 can be provided in various configurations, such as those described previously with respect to FIGS. 2a-2c.

Next, a first electrode 220 is formed on the wavelength narrowing mirror structure 150 and contacts a metal layer thereof. Suitable material of the first electrode 220 can comprise indium tin oxide (ITO), indium zinc oxide (IZO), aluminum zinc oxide (AZO), zinc oxide (ZnO), SnO2, In2O3, Mg, Ca, Al, Ba, Li, Be, Sr, Ag, Au or combinations thereof, formed by, for example, sputtering, electron beam evaporation, thermal evaporation, or chemical vapor deposition. Particularly, the metal materials such as Al, Cu, Mo, Ti, Pt, Ir, Ni, Cr, Ag, Au or combinations thereof is transparent or semitransparent.

An electroluminescent layer 230 is formed on the first electrode 220, wherein the electroluminescent layer 230 comprises at least a light emitting layer, and can further comprise a hole injection layer, a hole transport layer, an electron transport layer, and an electron injection layer. The electroluminescent layer 230 is organic semiconductor material such as small molecule material, polymer, or organometallic complex, and can be formed by thermal vacuum evaporation, spin coating, dip coating, roll-coating, injection-fill, embossing, stamping, physical vapor deposition, or chemical vapor deposition. The emitting layer can comprise one or multiple light-emitting materials and electroluminescent dopants doped into the light-emitting material and can perform energy transfer or carrier trapping under electron-hole recombination in the emitting layer. The light-emitting material can be fluorescent or phosphorescent. It should be noted that the electroluminescent layer 230 can comprise a single electroluminescent unit, resulting in an organic electroluminescent diode 200 with red, blue, or green emission or combinations thereof. Further, the electroluminescent layer 230 can comprise a plurality of electroluminescent units, thus, a tandem organic electroluminescent diode 200 with white emission can be achieved by mixing different colors.

Next, a second electrode 240 is formed on the electroluminescent layer 230. Suitable material of the electrode 240 can comprise indium tin oxide (ITO), indium zinc oxide (IZO), aluminum zinc oxide (AZO), zinc oxide (ZnO), SnO2, In2O3, Al, Cu, Mo, Ti, Pt, Ir, Ni, Cr, Ag, Au or combinations thereof, formed by, for example, sputtering, electron beam evaporation, thermal evaporation, or chemical vapor deposition.

The following illustrative examples are provided.

### White Organic Electroluminescent Device

### COMPARATIVE EXAMPLE 1

A glass substrate with an indium tin oxide (ITO) film of 120 nm in thickness was provided and then washed by a cleaning agent, acetone, and isopropanol with ultrasonic agitation. After drying with nitrogen flow, the ITO film was subjected to UV/ozone treatment. Next, a hole injection layer, hole transport layer, first light-emitting layer, second light-emitting layer, third light-emitting layer, electron transport layer, electron injection layer, aluminum electrode, and a silver electrode were subsequently formed on the ITO film at 10-5 Pa, obtaining the electroluminescent device (1).

For purposes of clarity, the materials and layers formed therefrom are described in the following.

The hole injection layer, with a thickness of 30 nm, consisted of [NOTE=“consisted of” has a very specific legal meaning, please ensure this is accurate] m-MTDATA (4,4′,4″-tris[(3-methylphenyl)phenylamino]triphenylamine). The hole transport layer, with a thickness of 20 nm, consisted of α-NPD (N,N′-di(naphtalene-1-yl)-N,N′-diphenyl-benxidine). The first light-emitting layer (with electron transport characteristic), with a thickness of 7.5 nm, consisted of ADN (Anthracene Dinaphthyl) as host, and Perylene as dopant, wherein the weight ratio between ADN and Perylene was 100:1. The second light-emitting layer (with electron transport characteristic), with a thickness of 5 nm, consisted of Alq₃ (tris(8-hydroxyquinoline) aluminum as host, and C545T (10-(2-Benzothiazolyl)-2,3,6,7-tetrahydro-1,1,7,7-tetramethyl-1H,5H, 11H-(1)-benzopyropyrano(6,7-8-i,j)quinolizin-11-one) as dopant, wherein the weight ratio between Alq₃ and C545T was 100:1. The third light-emitting layer (with electron transport characteristic), with a thickness of 7.5 nm, consisted of Alq₃ as host, and DCJTB (butyl-6-(1,1,7,7,-tetramethyljulolidyl-9-enyl)-4H-pyran) as dopant, wherein the weight ratio between Alq₃ and DCJTB was 1000:7. The hole transport layer, with a thickness of 40 nm, consisted of Alq₃. The electron injection layer, with a thickness of 0.5 nm, consisted of LiF. The aluminum electrode had a thickness of 1 nm. The silver electrode had a thickness of 100 nm.

The emissive structure of the electroluminescent device (1) can be represented as:

ITO 120 nm/m-MTDATA 30 nm/α-NPD 20 nm/ADN:Perylene 100:1 7.5 nm/Alq₃:C545T 100:1 5 nm/Alq₃:DCJTB 1000:7 7.5 nm/Alq₃ 40 nm/LiF 0.5 nm/Al 1 nm/Ag 100 nm

The optical properties of electroluminescent device (1), as described in Example 1, were measured by PR650 (purchased from Photo Research Inc.) and Minolta LS110.

### EXAMPLE 1

A glass substrate with an indium tin oxide (ITO) film of 120 nm in thickness was provided and then washed by a cleaning agent, acetone, and isopropanol with ultrasonic agitation. After drying with nitrogen flow, the ITO film was subjected to UV/ozone treatment. Next, a hole injection layer, hole transport layer, first light-emitting layer, second light-emitting layer, third light-emitting layer, electron transport layer, electron injection layer, aluminum electrode, and a wavelength narrowing mirror structure (comprising a first silver layer, first dielectric layer, second silver layer, second dielectric layer, and third silver layer), were subsequently formed on the ITO film at 10-5 Pa, obtaining the electroluminescent device (2).

For purposes of clarity, the materials and layers formed therefrom are described in the following.

The hole injection layer, with a thickness of 30 nm, consisted of m-MTDATA (4,4′,4″-tris[(3-methylphenyl)phenylamino]triphenylamine). The hole transport layer, with a thickness of 20 nm, consisted of α-NPD (N,N′-di(naphtalene-1-yl)-N,N′-diphenyl-benxidine). The first light-emitting layer (with electron transport characteristic), with a thickness of 7.5 nm, consisted of ADN (Anthracene Dinaphthyl) as host, and Perylene as dopant, wherein the weight ratio between ADN and Perylene was 100:1. The second light-emitting layer (with electron transport characteristic), with a thickness of 5 nm, consisted of Alq₃ (tris(8-hydroxyquinoline) aluminum as host, and C545T (10-(2-Benzothiazolyl)-2,3,6,7-tetrahydro-1,1,7,7-tetramethyl-1H,5H,11H-(1)-benzopyropyrano(6,7-8i,j)quinolizin-11-one) as dopant, wherein the weight ratio between Alq₃ and C545T was 100:1. The third light-emitting layer (with electron transport characteristic), with a thickness of 7.5 nm, consisted of Alq₃ as host, and DCJTB (butyl-6-(1,1,7,7,-tetramethyljulolidyl-9-enyl)-4H-pyran) as dopant, wherein the weight ratio between Alq₃ and DCJTB was 1000:7. The hole transport layer, with a thickness of 40 nm, consisted of Alq₃. The electron injection layer, with a thickness of 0.5 nm, consisted of LiF. The aluminum electrode had a thickness of 26 nm. The first silver electrode had a thickness of 8 nm. The first dielectric layer consisted of Alq₃ with a thickness of 90 nm. The second silver electrode had a thickness of 26 nm. The second dielectric layer consisted of Alq₃ with a thickness of 100 nm. The third silver electrode had a thickness of 150 nm.

The emissive structure of the electroluminescent device (2) can be represented as:

ITO 120 nm/m-MTDATA 30 nm/α-NPD 20 nm/AND Perylene 100:1 7.5 nm/Alq₃:C545T 100:1 5 nm/Alq₃:DCJTB 1000:7 7.5 nm/Alq₃ 40 nm/LiF 0.5 nm/Al 1 nm/Ag 8 nm/Alq₃ 90 nm/Ag 26 nm/Alq₃ 100 nm/Ag 150 nm

The optical properties of electroluminescent device (2), as described in Example 1, were measured by PR650 (purchased from Photo Research Inc.) and Minolta LS110.

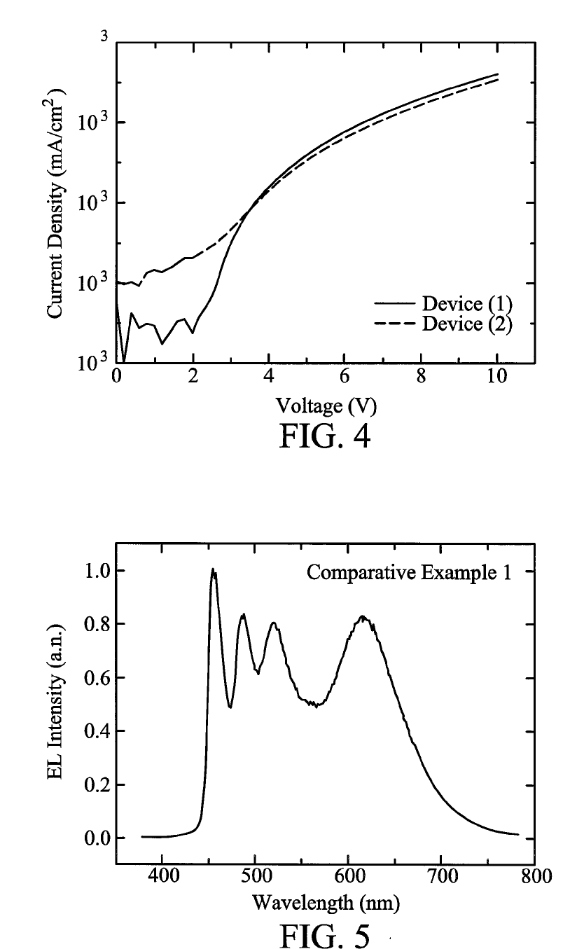

FIG. 4 is a graph plotting operating voltage against current density of the electroluminescent devices (1) and (2) as disclosed in Comparative Example 1 and Example 1.

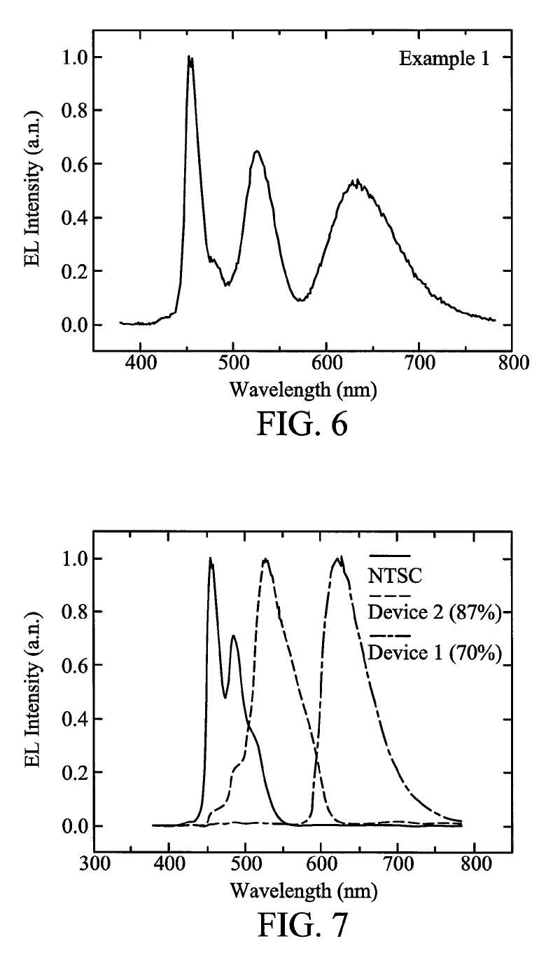

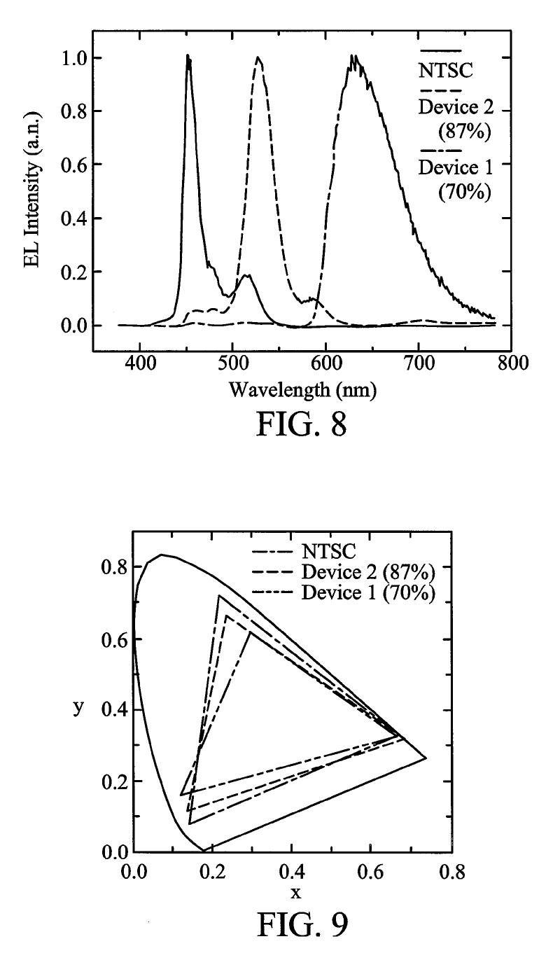

FIGS. 5 and 6 show electroluminescent spectra as described, respectively, in Comparative Example 1 and Example 1. Accordingly, in comparison with Comparative Example 1, the spectral FWHM of RGB emissions of the electroluminescent device (2) is obviously narrowed by the wavelength narrowing mirror structure. Further, referring to FIGS. 7 and 8, after passing through the RGB color filters, the electroluminescent device (2) has more saturated RGB emissions than that of electroluminescent device (1), resulting in a widened color range.

Further, referring to FIG. 9, the color saturation (NTSC ratio) of the electroluminescent device (2) with the wavelength narrowing mirror structure exceeds that of electroluminescent device (1). As a result, due to the wavelength narrowing mirror structure, the color gamut is increased from 70% to 87%.

Accordingly, various embodiments of an organic electroluminescent device with wavelength narrowing mirror structure provide simplified structure and fabrication process and exhibit increased color saturation (NTSC ratio), resulting in a system for display images with increased color range.

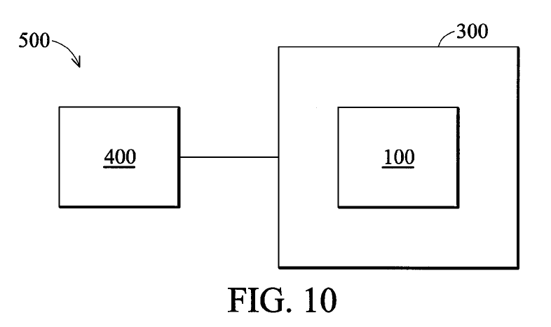

FIG. 10 schematically shows another embodiment of a system for displaying images which, in this case, is implemented as a display panel 300 or an electronic device 500. The disclosed active matrix organic electroluminescent device can be incorporated into a display panel that can be an OLED panel. As shown in FIG. 10, the display panel 300 comprises an active matrix organic electroluminescent device, such as the active matrix organic electroluminescent device 100 shown in FIG. 1. The display panel 300 can be applied in a variety of electronic devices (in this case, electronic device 500). Generally, the electronic device 500 can comprise the display panel 300 and an input unit 400. Further, the input unit 400 is operatively coupled to the display panel 300 and provides input signals (e.g., an image signal) to the display panel 300 to generate images. The electronic device 500 can be a mobile phone, digital camera, PDA (personal data assistant), notebook computer, desktop computer, television, car display, or portable DVD player, for example.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
an electroluminescent device, comprising:
a substrate;
a first electrode located on the substrate;
electroluminescent layers located on the first electrode;
a second electrode located on the electroluminescent layers; and
a wavelength narrowing mirror structure located directly on the second electrode, wherein the wavelength narrowing mirror structure comprises a plurality of metal layers, with two adjacent ones of the metal layers being separated by a dielectric layer.

2. The system as claimed in claim 1, wherein each of the metal layers is transparent or semitransparent.

3. The system as claimed in claim 1, wherein the metal layers are formed of the same materials

4. The system as claimed in claim 1, wherein the dielectric layer comprises an inorganic compound.

5. The system as claimed in claim 1, wherein the dielectric layer comprises an organic compound.

6. The system as claimed in claim 1, wherein the wavelength narrowing mirror structure has at least two dielectric layers.

7. The system as claimed in claim 4, wherein the dielectric layer comprises TeO₂, ITO, ZrO, ZnO, ZnSe, ZnS, MgO, Si₃N₄, SiO₂, LiF, MgF₂, NaF, CaF₂, or combinations thereof.

8. The system as claimed in claim 5, wherein the dielectric layer comprises 4,4′,4″-tris[(3-methylphenyl)phenylamino]triphenylamine(m-MTDATA), N,N′-di(naphtalene-1-yl)-N,N′-diphenyl-benxidine (α-NPD), 4,4′-bis(m-tolyphenylamino) biphenyl (TPD), anthracene dinaphthyl (ADN), tris(8-hydroxyquinoline) aluminum (Alq₃), or combinations thereof.

9. The system as claimed in claim 1, wherein the electroluminescent device emits white light.

10. The system as claimed in claim 1, wherein the first electrode comprises ITO, IZO, AZO, ZnO, SnO2, In2O3, or combinations thereof.

11. The system as claimed in claim 1, wherein the wavelength narrowing mirror structure comprises two metal layers separated by one dielectric layer.

12. The system as claimed in claim 1, wherein the wavelength narrowing mirror structure comprises three metal layers, and two adjacent metal layers are separated by one dielectric layer.

13. The system as claimed in claim 1, further comprising an electronic device, wherein the electronic device comprises:
the electroluminescent device; and
an input unit coupled to the electroluminescent device.

14. The system as claimed in claim 13, wherein the electronic device is a mobile phone, digital camera, PDA (personal digital assistant), notebook computer, desktop computer, television, car display, or portable DVD player.

15. A system for displaying images, comprising:
an electroluminescent device, comprising:
a substrate; and
a wavelength narrowing mirror structure located on the substrate, wherein the wavelength narrowing mirror structure comprises a plurality of metal layers with two adjacent ones of the metal layers being separated by a dielectric layer, the electroluminescent device being operative to emit red, green, and blue (RGB) emissions, wherein the wavelength narrowing mirror structure increases saturation of the RGB emissions.

16. The system as claimed in claim 15, wherein the wavelength narrowing mirror structure has at least two dielectric layers.

17. The system as claimed in claim 15, wherein the wavelength narrowing mirror structure comprises two metal layers separated by one dielectric layer.

18. The system as claimed in claim 15, wherein the wavelength narrowing mirror structure comprises three metal layers, and two adjacent metal layers are separated by one dielectric layer.

19. The system as claimed in claim 15, further comprising an electronic device, wherein the electronic device comprises:
the electroluminescent device; and
an input unit coupled to the electroluminescent device.

20. The system as claimed in claim 19, wherein the electronic device is a mobile phone, digital camera, PDA (personal digital assistant), notebook computer, desktop computer, television, car display, or portable DVD player.
